(19) United States
(12) Patent Application Publication
(10) Pub. No.: US 2026/0169590 A1
(43) Pub. Date: Jun. 18, 2026

(54) DRIVING DEVICE FOR CAPACITIVE TOUCH PANEL

(71) Applicant: Raydium Semiconductor Corporation, Hsinchu (TW)

(72) Inventors: FU-YUAN CHENG, Hsinchu (TW); I-JEN CHAO, Hsinchu (TW); MING-WEI KUNG, Hsinchu (TW)

(21) Appl. No.: 19/184,050

(22) Filed: Apr. 21, 2025

(30) Foreign Application Priority Data
Dec. 17, 2024 (TW) 113149132

(51) Int. Cl. G06F 3/041; G06F 3/044

(52) U.S. Cl. CPC G06F 3/04184; G06F 3/0412; G06F 3/044

(57) ABSTRACT

A driving device for driving a capacitive touch panel is disclosed. The capacitive touch panel is provided with a plurality of touch sensing electrodes. The driving device includes a touch driving circuit. The touch driving circuit is coupled to the plurality of touch sensing electrodes. During a touch sensing period of the capacitive touch panel, the touch driving circuit is configured to output a touch sensing driving signal to at least one touch sensing electrode of the plurality of touch sensing electrodes and to synchronously output a touch co-driving signal in phase with the touch sensing driving signal to other touch sensing electrodes of the plurality of touch sensing electrodes. In an initial first interval of the touch sensing period, the touch co-driving signal has a first slope waveform. In a last second interval of the touch sensing period, the touch co-driving signal has a second slope waveform.

### TECHNICAL FIELD

The invention relates to a touch panel, and more particularly to a driving device for a capacitive touch panel.

### BACKGROUND

In general, touch sensing driving signals on the entire capacitive touch panel will generate relatively strong electromagnetic interference (EMI). In particular, for the capacitive touch panel supporting self-capacitive sensing, in order to overcome the parasitic capacitance on the panel, during the touch sensing period, the touch sensors that are not sensing still need to be driven by the touch driving signals (capacitance-free driving, CFD) that is in phase with the touch sensing driving signals. As shown in FIG. 1, all touch sensors TS on the entire capacitive touch panel PL are in the sensing waveform, thereby generating stronger electromagnetic interference EMI.

The above-mentioned EMI is related to the waveform and frequency of the touch sensing driving signal. Please refer to FIG. 2, which is a waveform timing diagram of a touch sensing driving signal of a touch and display driver integration (TDDI) chip operated with a negative voltage. The touch sensing driving circuit and the display driving circuit are operated in a time-sharing manner. When the capacitive touch panel enters a touch sensing period, a front-setting period FS is used to sequentially turn on each touch circuit and turn off the display driving circuit. At the end of the front-setting period FS, a voltage difference of the touch driving signal VCFD drops instantly (as shown by the dotted circle), which will cause strong EMI emissions. Similarly, when the sine wave (which can also be a square wave, trapezoidal wave, triangle wave, etc.) waveform of the touch driving signal VCFD ends and is about to enter a back-setting period BS, the instantaneous rising voltage difference of the touch driving signal VCFD (such as the dotted circle) will also cause strong EMI emissions. The back-setting period is used to sequentially turn off each touch circuit and turn on the display driving circuit.

In addition, based on the different operating principles of the sensing circuit, the touch sensing driving signals can be divided into square wave driving signals and sine wave driving (including trapezoidal wave and triangle wave) signals. As shown in FIG. 3, more obvious EMI will be caused by the rising edge/falling edge of the waveform of the square wave driving signals. The steeper slope of the rising edge/falling edge of the waveform, the greater EMI radiated. In addition, the EMI of the waveform of the square wave driving signals is also accompanied by EMI of odd harmonic frequencies of the driving frequency.

Therefore, the above-mentioned problems encountered by the prior art still need to be solved.

### SUMMARY

In view of this, a driving device for a capacitive touch panel is proposed in the invention to effectively solve the above-mentioned problems in the prior art.

A preferred embodiment of the invention is a driving device for driving a capacitive touch panel. In this embodiment, the driving device is used for driving a capacitive touch panel provided with a plurality of touch sensing electrodes. The driving device includes a touch driving circuit. The touch driving circuit is used to couple the plurality of touch sensing electrodes. During a touch sensing period of the capacitive touch panel, the touch driving circuit is configured to output a touch sensing driving signal to at least one touch sensing electrode of the plurality of touch sensing electrodes and synchronously output a touch co-driving signal in phase with the touch sensing driving signal to other touch sensing electrodes of the plurality of touch sensing electrodes. In a first interval at the front of the touch sensing period, the touch co-driving signal has a first slope waveform. In a second interval at the end of the touch sensing period, the touch co-driving signal has a second slope waveform.

In an embodiment, the touch driving circuit includes a front-end analog touch circuit and a co-driving driving circuit.

In an embodiment, the front-end analog touch circuit is configured to output the touch sensing driving signal to the at least one touch sensing electrode of the plurality of touch sensing electrodes and the co-driving driving circuit is configured to synchronously output the touch co-driving signal in phase with the touch sensing driving signal to the other touch sensing electrodes of the plurality of touch sensing electrodes.

In an embodiment, the first slope waveform and the second slope waveform are a slow-down waveform and a slow-up waveform respectively.

In an embodiment, the first slope waveform and the second slope waveform each comprise a plurality of segments with different slopes.

In an embodiment, in a third interval between the first interval and the second interval, the touch co-driving signal has a window function waveform.

In an embodiment, the window function waveform is a window sinusoidal waveform, a window trapezoid waveform, a window triangle waveform or a window square waveform.

In an embodiment, in a third interval between the first interval and the second interval, the touch co-driving signal has an adjusted square wave waveform.

In an embodiment, the touch driving circuit further includes: a driving operational amplifier having a first input terminal, a second input terminal and an output terminal, wherein the first input terminal is coupled to the output terminal and the output terminal outputs the touch sensing driving signal with an adjusted square wave waveform; an adjustable resistor coupled to the second input terminal; and an adjustable capacitor coupled between the second input terminal and a ground terminal; wherein the adjusted square wave waveform is a square wave waveform filtered by the adjustable resistor and the adjustable capacitor.

In an embodiment, the driving device is a touch driving chip, the capacitive touch panel is also coupled to a display driving chip, during a display period of the capacitive touch panel, the display driving chip is configured to output a display driving signal to at least one pixel of a plurality of pixels of the capacitive touch panel to display a screen.

In an embodiment, the driving device is a touch and display driver integration (TDDI) chip, and the driving device further includes: a display driving circuit coupled to a plurality of pixels of the capacitive touch panel, during a display period of the capacitive touch panel, the display driving circuit outputs a display driving signal to at least one pixel of the plurality of pixels to display a screen.

In an embodiment, the display period and the touch sensing period of the capacitive touch panel are time-divided and have no overlapping time.

Compared with the prior art, the driving device for the capacitive touch panel proposed in the invention utilizes a slope waveform having one or more segments in an initial interval and a last interval of the touch sensing period and a co-driving signal having a window function waveform in the middle segment to significantly reduce the EMI emitted by the touch sensor that is not sensing when driven by the co-driving signal, thereby effectively reducing the overall radiation energy of the capacitive touch panel.

### BRIEF DESCRIPTION OF THE DRAWINGS

FIG. 1 illustrates a schematic diagram showing that all touch sensors on the entire capacitive touch panel are in a sensing waveform, thereby generating stronger EMI.

FIG. 2 illustrates a waveform timing diagram of a touch sensing driving signal (sine wave waveform) of a self-capacitor operating with a negative voltage.

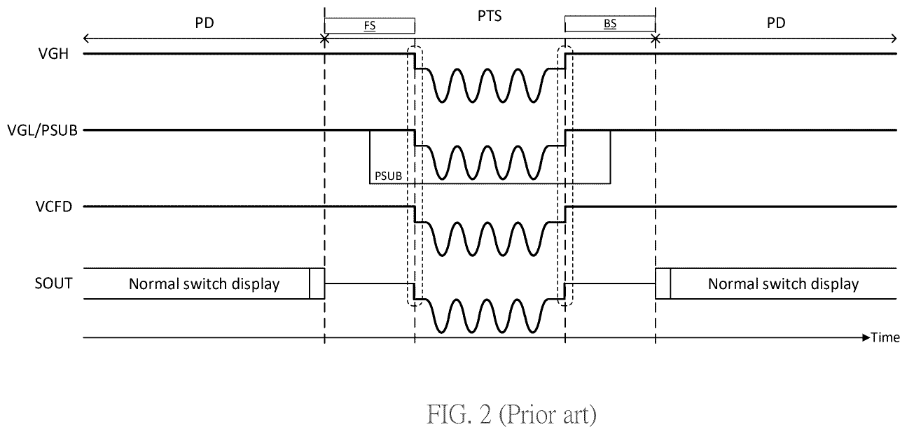

FIG. 3 illustrates a waveform timing diagram of a touch sensing driving signal (square wave waveform) of a self-capacitor operating with a negative voltage.

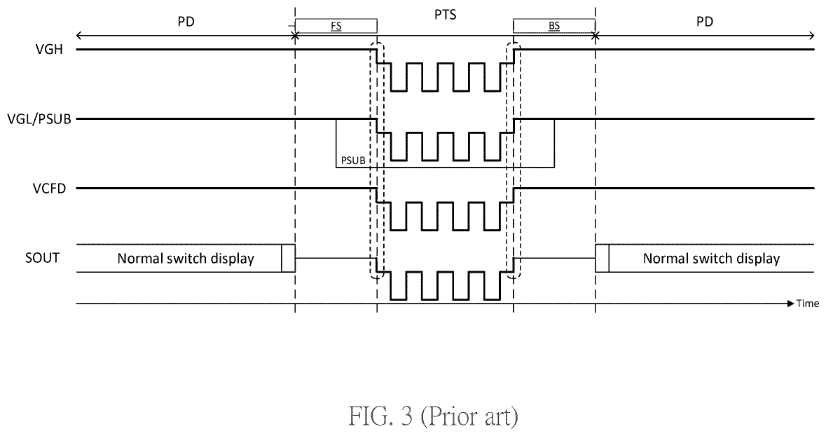

FIG. 4 illustrates a waveform timing diagram of a touch sensing driving signal and a co-driving signal in a preferred embodiment of the invention.

FIG. 5 and FIG. 6 illustrate schematic diagrams showing that the first ramp waveform and the second ramp waveform include one or more slope segments respectively.

FIG. 7 illustrates a schematic diagram showing that a touch sensing driving signal is directly inputted to a driving operational amplifier and then outputted by the driving operational amplifier and then transmitted to the proximal end and the far end in sequence.

FIG. 8 illustrates a schematic diagram showing that the touch sensing driving signal is first adjusted by the resistor and the capacitor and then inputted to the driving operational amplifier and then outputted by the driving operational amplifier and then transmitted to the proximal end and the far end in sequence.

### DETAILED DESCRIPTION

A preferred embodiment of the invention is a driving device for a capacitive touch panel. In this embodiment, the driving device is used to drive a capacitive touch panel and the capacitive touch panel may have different types of panel architectures, such as embedded type (also divided into in-cell and on-cell), external type (out-cell), etc., and may adopt different types of touch sensing methods (such as self-capacitance or mutual capacitance sensing).

In fact, the driving device can be a touch and display driver integration (TDDI) chip, which includes a touch driving circuit and a display driving circuit. The display driving circuit is coupled to a plurality of pixels of the capacitive touch panel. During a display period of the capacitive touch panel, the display driving circuit outputs a display driving signal to at least one pixel of the plurality of pixels to display a picture. The touch driving circuit is coupled to the plurality of touch sensing electrodes on the capacitive touch panel. During a touch sensing period of the capacitive touch panel, the touch driving circuit outputs a touch sensing driving signal to drive at least one touch sensing electrode of the plurality of touch sensing electrodes to perform touch sensing.

In addition, the driving device can also be a simple touch driving chip. The touch driving chip is coupled to the plurality of touch sensing electrodes on the capacitive touch panel. During the touch sensing period of the capacitive touch panel, the touch driving chip outputs a touch sensing driving signal to drive at least one touch sensing electrode of the plurality of touch sensing electrodes to perform touch sensing. The capacitive touch panel is also coupled to the display driver chip. During the display period of the capacitive touch panel, the display driver chip outputs a display driving signal to at least one pixel of the plurality of pixels of the capacitive touch panel to display an image.

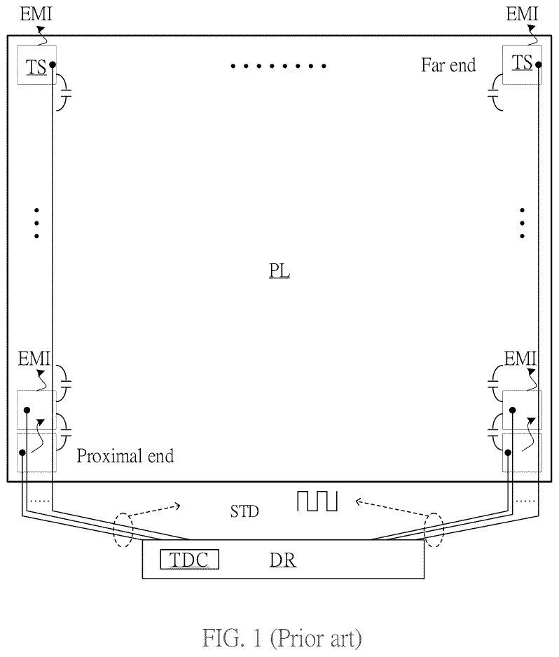

For example, as shown in FIG. 1, a plurality of touch sensing electrodes TS is disposed on the capacitive touch panel PL, and the driving device DR includes a touch driving circuit TDC, and the touch driving circuit TDC is coupled to the plurality of touch sensing electrodes TS on the capacitive touch panel PL.

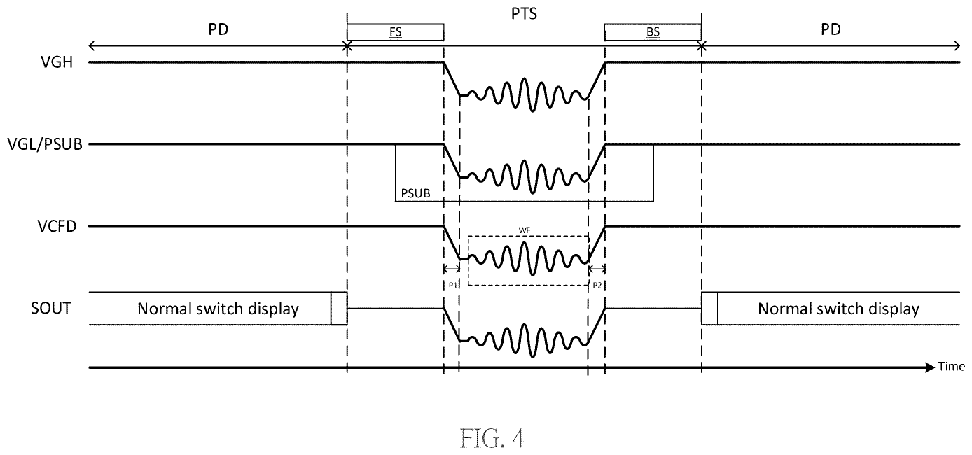

As shown in FIG. 4, the capacitive touch panel PL is driven by the touch driving circuit TDC to perform touch sensing during the touch sensing period PTS, and the capacitive touch panel PL is driven by the display driving circuit during the display period PD to display the image, and the touch sensing period PTS and the display period PD are time-divided with each other without overlapping time.

It should be noted that, during the touch sensing period PTS of the capacitive touch panel PL, the touch driving circuit TDC outputs a touch sensing driving signal STD to at least one touch sensing electrode TS among the plurality of touch sensing electrodes TS to perform touch sensing. At the same time, the touch driving circuit TDC also synchronously outputs a touch co-driving signal VCFD in phase with the touch sensing driving signal STD to other touch sensing electrodes TS among the plurality of touch sensing electrodes TS that are not performing touch sensing.

In actual applications, the touch driving circuit TDC may include a front-end analog touch circuit and a co-driving driving circuit, wherein the front-end analog touch circuit is used to output the touch sensing driving signal STD to at least one touch sensing electrode TS among the plurality of touch sensing electrodes TS for touch sensing, and the co-driving driving circuit is used to synchronously output the touch co-driving signal VCFD that is in phase with the touch sensing driving signal STD to other touch sensing electrodes TS among the plurality of touch sensing electrodes TS that are not performing touch sensing, but not limited to this.

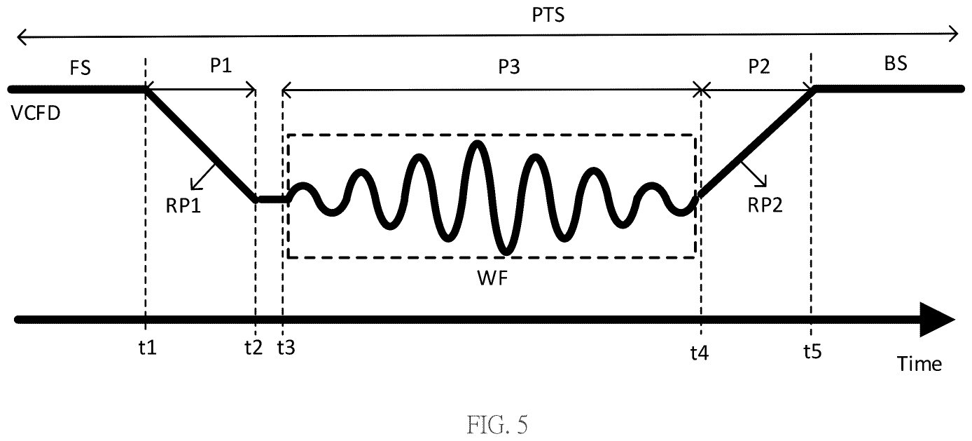

Please refer to FIG. 5. When the capacitive touch panel PL enters the touch sensing period PTS, the front setting period FS is used to sequentially turn on each touch circuit and turn off the display driving circuit. At this time, the touch driving signal VCFD maintains a constant value. At a time t1, the front setting period FS ends and the signal enters a first interval P1, and the touch driving signal VCFD begins to decrease slowly and has a first ramp waveform RP1, and the first ramp waveform RP1 has a first slope until a time t2.

In a third interval P3 from a time t3 to a time t4, the touch driving signal VCFD has a window function waveform WF. It should be noted that the window function waveform WF in this embodiment is a window sinusoidal waveform, but in fact it can also be a window trapezoidal waveform, a window triangular waveform or a window square waveform, and not limited to this.

In a second interval P2 from a time t4 to a time t5, the touch driving signal VCFD starts to rise slowly and has a second ramp waveform RP2, and the second ramp waveform RP2 has a second slope different from the first slope until the time t5. At the time t5, a back setting period BS begins. The back setting period BS is used to sequentially turn off each touch circuit and turn on the display driving circuit. The touch driving signal VCFD maintains a constant value.

It should be noted that since the touch driving signal VCFD has a first ramp waveform RP1 that slowly decreases and a second ramp waveform RP2 that slowly increases, it can effectively avoid strong EMI emissions caused by the instantaneous decreasing/increasing voltage difference of the touch driving signal VCFD in the prior art. In addition, the touch driving signal VCFD also has a window function waveform WF, which also helps to reduce EMI emissions.

In practical applications, the first ramp waveform RP1 and the second ramp waveform RP2 may also include a plurality of segments with different slopes. As shown in FIG. 6, in the first interval P1 (from the time t1 to the time t3), the first ramp waveform RP1 includes a first section SL1 (from the time t1 to the time t2) and a second section SL2 (from the time t2 to the time t3) having different slopes. In the second interval P2 (from the time t5 to the time t7), the second ramp waveform RP2 includes a third section SL3 (from the time t5 to the time t6) and a fourth section SL4 (from the time t6 to the time t7) having different slopes.

It should be noted that since the touch co-driving signal VCFD has a first slope waveform RP1 with a step-by-step slow-down and a second slope waveform RP2 with a step-by-step slow-up, it can more effectively avoid strong EMI emissions caused by the instantaneous falling/rising voltage difference of the touch co-driving signal VCFD in the prior art. In addition, the touch driving signal VCFD also has a window function waveform WF, which also helps to reduce EMI emissions.

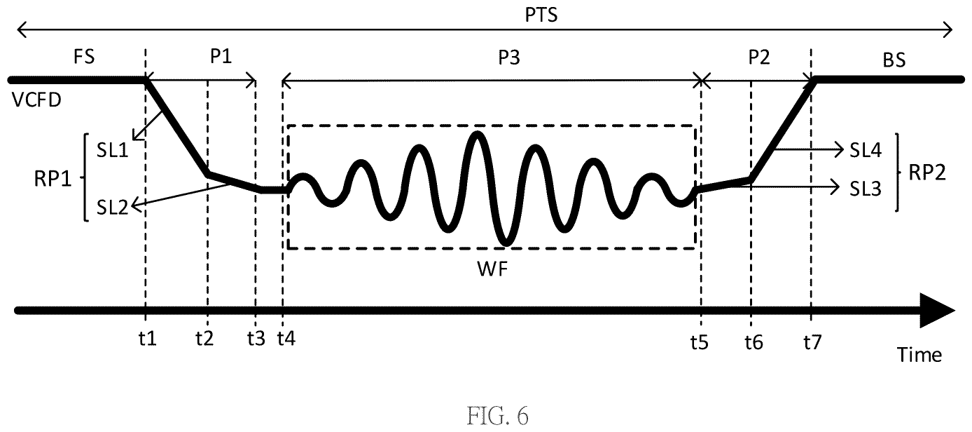

Please refer to FIG. 7. As shown in FIG. 7, the touch sensing driving signal VDR having a square wave waveform is directly inputted to a positive input terminal + of a driving operational amplifier DOP, that is, the input signal VINP is the touch sensing driving signal VDR having a square wave waveform. An output terminal of the driving operational amplifier DOP outputs a touch sensing driving signal VDRO and then the touch sensing driving signal VDRO is transmitted to the proximal end RX_1 to the far end RX_N in sequence. Since the driving operational amplifier DOP outputs the touch sensing driving signal VDRO with a square wave waveform, when it is transmitted to the proximal end RX_1 and the far end RX_N in sequence, its waveform will gradually weaken due to the RC charge-discharge effect, resulting in a waveform of the far end voltage VRX_N at the far end RX_N that is significantly different from the waveform of the proximal end voltage VRX_1 at the proximal end RX_1, with smoother waveform edges and even reduced amplitude.

In another embodiment, in the third interval P3, the touch driving signal VCFD that is in phase with the touch sensing driving signal VDR may also have an adjusted square wave waveform. For example, the adjusted square wave waveform may be a square wave waveform filtered by an adjustable resistor and an adjustable capacitor, but not limited to this.

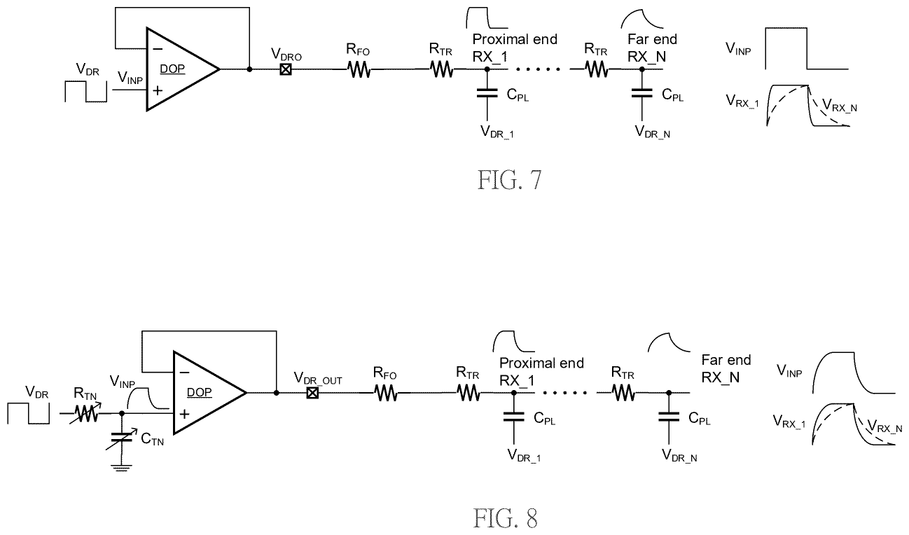

As shown in FIG. 8, the driving operational amplifier DOP has a positive input terminal +, a negative input terminal − and an output terminal. The negative input terminal − is coupled to the output terminal. An adjustable resistor RTN is coupled to the positive input terminal +. An adjustable capacitor CTN is coupled between the positive input terminal + and the ground terminal. The touch sensing driving signal VDR is first filtered by the adjustable resistor RTN and the adjustable capacitor CTN and then inputted to the positive input terminal + of the driving operational amplifier DOP. That is, the input signal VINP is the touch sensing driving signal VDR with an adjusted square wave waveform that has been pre-attenuated. An output terminal of the driving operational amplifier DOP outputs a touch sensing driving signal VDR_OUT having an adjusted square wave waveform and is then transmitted to the proximal end RX_1 to the far end RX_N in sequence. Since the touch sensing driving signal VDR_OUT outputted by the driving operational amplifier DOP has the pre-attenuated square wave waveform, the waveform difference between the far end voltage VRX_N at the far end RX_N and the proximal end voltage VRX_1 at the proximal end RX_1 becomes smaller. Therefore, the method proposed in the invention can obtain a far end voltage VRX_N waveform that is very close to the far end voltage VRX_N waveform obtained by the conventional method of FIG. 7, but the waveform of the proximal end voltage VRX_1 is smoother than the proximal end voltage VRX_1 waveform obtained by the conventional method of FIG. 7, thereby reducing the EMI generated by the proximal end touch sensor when driven by the same driving signal.

Compared with the prior art, the driving device for the capacitive touch panel proposed in the present invention utilizes a slope waveform having one or more segments in the initial interval and the last interval of the touch sensing period and a co-driving signal having a window function waveform in the middle segment to significantly reduce the electromagnetic interference emitted by the touch sensor that is not sensing when driven by the co-driving signal, thereby effectively reducing the overall radiation energy of the capacitive touch panel.

The contents disclosed above are merely feasible embodiments of the invention, and are not intended to limit the scope of the claims of the invention. Therefore, all equivalent technical changes made based on the specification and the drawings of the invention fall within the scope of the claims of the invention.

1. A driving device for driving a capacitive touch panel provided with a plurality of touch sensing electrodes, the driving device comprising:
a touch driving circuit coupled to the plurality of touch sensing electrodes, wherein during a touch sensing period of the capacitive touch panel, the touch driving circuit is configured to output a touch sensing driving signal to at least one touch sensing electrode of the plurality of touch sensing electrodes and synchronously output a touch co-driving signal in phase with the touch sensing driving signal to other touch sensing electrodes of the plurality of touch sensing electrodes;
wherein in a first interval at the front of the touch sensing period, the touch co-driving signal has a first slope waveform; in a second interval at the end of the touch sensing period, the touch co-driving signal has a second slope waveform; the first slope waveform and the second slope waveform each comprise a plurality of line segments with different slopes.

2. The driving device according to claim 1, wherein the touch driving circuit comprises a front-end analog touch circuit and a co-driving driving circuit.

3. The driving device according to claim 2, wherein the front-end analog touch circuit is configured to output the touch sensing driving signal to the at least one touch sensing electrode of the plurality of touch sensing electrodes and the co-driving driving circuit is configured to synchronously output the touch co-driving signal in phase with the touch sensing driving signal to the other touch sensing electrodes of the plurality of touch sensing electrodes.

4. The driving device according to claim 1, wherein the first slope waveform and the second slope waveform are a slow-down waveform and a slow-up waveform respectively.

5. (canceled)

6. The driving device according to claim 1, wherein in a third interval between the first interval and the second interval, the touch co-driving signal has a window function waveform.

7. The driving device according to claim 6, wherein the window function waveform is a window sinusoidal waveform, a window trapezoid waveform, a window triangle waveform or a window square waveform.

8. The driving device according to claim 1, wherein in a third interval between the first interval and the second interval, the touch co-driving signal has an adjusted square wave waveform.

9. The driving device according to claim 1, wherein the touch driving circuit further comprises:
a driving operational amplifier having a first input terminal, a second input terminal and an output terminal, wherein the first input terminal is coupled to the output terminal and the output terminal outputs the touch sensing driving signal with an adjusted square wave waveform;
an adjustable resistor coupled to the second input terminal; and
an adjustable capacitor coupled between the second input terminal and a ground terminal;
wherein the adjusted square wave waveform is a square wave waveform filtered by the adjustable resistor and the adjustable capacitor.

10. The driving device according to claim 1, wherein the driving device is a touch driving chip, the capacitive touch panel is also coupled to a display driving chip, during a display period of the capacitive touch panel, the display driving chip is configured to output a display driving signal to at least one pixel of a plurality of pixels of the capacitive touch panel to display a screen.

11. The driving device according to claim 1, wherein the driving device is a touch and display driver integration (TDDI) chip, and the driving device further comprises:
a display driving circuit coupled to a plurality of pixels of the capacitive touch panel, during a display period of the capacitive touch panel, the display driving circuit outputs a display driving signal to at least one pixel of the plurality of pixels to display a screen.

12. The driving device according to claim 11, wherein the display period and the touch sensing period of the capacitive touch panel are time-divided and have no overlapping time.

13. The driving device according to claim 1, wherein in a third interval between the first interval and the second interval, the touch co-driving signal has a window trapezoid waveform or a window triangle waveform.
